(19) United States
(12) Patent Application Publication
(10) Pub. No.: US 2008/0177701 A1
(43) Pub. Date: Jul. 24, 2008

(54) SYSTEM AND METHOD FOR SEARCHING A VOLUME OF FILES

(75) Inventors: Robert W. Merritt, Houston, TX (US); Vickie K. Coulter, Brenham, TX (US)

Correspondence Address: FULBRIGHT & JAWORSKI L.L.P, 2200 ROSS AVENUE, SUITE 2800, DALLAS, TX, 75201-2784, US

(73) Assignee: TOTAL E&P USA, INC., Houston, TX (US)

(21) Appl. No.: 11/625,960

(22) Filed: Jan. 23, 2007

(51) Int. Cl. G06F 17/30

(52) U.S. Cl. 707/3; 707/6; 707/E17.014

(57) ABSTRACT

A pathname-based index is constructed for use in searching for a file of interest that resides in a volume of files. Thus, information contained in the paths present in the volume of files (e.g., directories and subdirectories) is used for efficiently searching for a file of interest. According to certain embodiments, an indexing application searches a volume of files and retrieves information (e.g., metadata) about the files contained therein for storage to a database that can then be searched, rather than requiring the full volume itself to be searched. Further, the file information (e.g., metadata) is indexed in the database based on the files' respective pathname in the volume of files. Thus, information contained in the file's pathname can be utilized in searching the database for information about the file (e.g., for discovering the file as being of interest).

### CROSS-REFERENCE TO RELATED APPLICATIONS

Not applicable.

### TECHNICAL FIELD

The following description relates generally to file searching techniques and more particularly to techniques for indexing information stored to a database about files based on the files' respective pathname in a volume of files.

### BACKGROUND OF THE INVENTION

Today, a large amount of information is stored electronically. Large volumes of files may exist within, for example a company's file server, which may result in difficulties and/or inefficiencies in attempting to find a given file that is of interest. Further compounding this problem is that different users typically do not adhere to a common file storage convention, and thus typically use different naming conventions for the files and the pathname leading to the files (e.g., directory and sub-directory names). In some environments, many different users may store files to a commonly accessible volume of files, such as a company-wide file server. Again, the different users may employ different file storage conventions (e.g., different naming conventions, etc.), and the file storage convention used by each individual user may change from time-to-time.

Often, users desire to find files for which the users do not know the exact pathname and/or filename. For instance, one user may desire to find in a volume of files a certain file that the user created earlier or that a different user created, wherein the searching user cannot remember or otherwise does not know the exact pathname and filename of the desired file. Thus, various search techniques have been developed in the art to assist users in searching a volume of files for a desired file based on certain information that the users know about the desired file. In this manner, the search techniques can assist a user in finding a file without requiring the user to know the full pathname and filename of the desired file.

Zen files are stored, the files themselves typically contain certain associated meta-data, such as file name, file author, file date (e.g., creation date), and file size. One search technique of the prior art receives a search criteria from a user about certain metadata, and then searches the volume of files for files that contain metadata satisfying the search criteria. For instance, a user may define a search criteria for searching for a file that contains a certain term in the filename (irrespective of the path leading to the file, i.e., irrespective of the directory and subdirectory to which the file may be stored) and/or that was created within a certain date range; in which case, the search technique searches the volume of files and analyzes the metadata associated with each file to determine those files, if any, that match the defined search criteria. Identification of any files identified as matching the defined search criteria can then be returned to the requesting user. Searching though a large volume of files can, however, be very inefficient and time consuming. For instance, a search of this type can take hours or even days in some instances, depending on the size of the volume being searched.

Another search method that has been developed has involved creating a separate database of information about the files in a volume that can be searched instead of searching the full volume of files itself. For instance, both Google™ and Microsoft™ have developed search techniques of this type. In traditional search techniques of this type, certain metadata information is retrieved from the files and stored in a separate database. The information is indexed in the database using the filename and/or other metadata such as the file author, the file creation date, and the file size, which is metadata that is often generated automatically (erg., by an operating system, such as Microsoft Windows™) for files. Often, the database stores the contents of the files themselves for certain types of files that are of interest, and the content of each file is indexed in the database using the above-mentioned metadata from the corresponding file. This type of search technique results in storage of an enormous amount of information in the database, usually about 25%-30% of the actual volume of files, which generally takes a long time to compile. Further, the search of the database for files of interest is limited to searching based on the file metadata that is stored for each file.

### BRIEF SUMMARY OF THE INVENTION

The present invention is directed to systems and methods for constructing a pathname-based index for use in searching for a file of interest that resides in a volume of files. That is, embodiments of the present invention make use of information contained in the paths present in the volume of files (e.g., directories and subdirectories) for efficiently searching for a file of interest. According to certain embodiments, an indexing application searches a volume of files and retrieves information (e-g., metadata) about the files contained therein for storage to a database that can then be searched, rather than requiring the full volume itself to be searched. Further, in certain embodiments, the file information (e.g., metadata) is indexed in the database based on the files' respective pathname in the volume of files. For instance, if a file “File_A” is stored in the volume of files at a pathname “root/myfiles/” (i.e., so that the file can be accessed at “root/myfiles/File_A”), then information about the file is indexed in the database with index “root/myfiles/” (i.e., the pathname leading to the file). In this way, as discussed further herein, embodiments of the present invention enable information contained in the file's pathname used in the volume of files to be utilized in searching the database for information about the file (e.g., for discovering the file as being of interest).

The inventors of the present application have recognized that logical information about a file often resides in the pathname that leads to the file, and this information has gone untapped in prior searching techniques. As an example, a user creating a document relating to a certain piece of equipment may define a pathname leading to the file that contains a term relating to such piece of equipment, such as the term “equipment” the equipment name or part number, and/or other information relating to the piece of equipment. For instance, the user may create a pathname “root/myfiles/equipment” within the volume of files to which the given file about the piece of equipment is stored Users often create pathname in this manner such that the pathname contain logical information relating to the files to which the paths lead. Continuing with the above example, a user later desiring to find a file relating to the piece of equipment may not know he filename and/or other metadata about the file itself, but embodiments of the present invention enable the user to search for terms that are likely present in the pathname leading to the desired file, such as “equipment” in the above example.

In this way, files that reside in the volume of files at a pathname that contains the term(s) specified by a user can be identified. Accordingly, the ability to search for files based on information that is contained in the pathname leading to such files in the volume of files may provide a powerful search ability, particularly when the user knows little information about the metadata of the desired file itself, such as the file's name. Of course, further search criteria may be employed in certain embodiments to enable a user to further refine a search. For instance in certain embodiments a user may define a search criteria that specifies one or more terms to be included in the pathname of a desired file, as well as certain metadata requirements for the desired file. For example, the user may define a search criteria that specifies the pathname is to contain the term “equipment” and the file creation date is to be within the last year (or within some other date range), wherein the database of file information can be searched to identify those records having pathname-based indexes that contain the term “equipment” and then of those records the file metadata information can be further analyzed to identify those records, if any, that correspond to files that have been created in the last year. The resulting identification of files, if any, can then be returned to the user.

This provides an efficient search technique that offers a user greater flexibility as to the type of information that can be used in searching for files in a large volume. In particular, the pathname-based index of file information enables such advantages that have heretofore gone unrecognized in prior search techniques.

The foregoing has outlined rather broadly the features and technical advantages of the present invention in order that the detailed description of the invention that follows may be better understood. Additional features and advantages of the invention w ill be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constrictions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an exemplary system according to one embodiment of the present invention;

FIG. 2 shows another exemplary system according to an embodiment of the present invention;

FIG. 3 shows another exemplary system, which illustrates an exemplary volume of files and an exemplary database that may be constructed according to one embodiment of the present invention;

FIG. 4 shows an operational flow according to one embodiment of the present invention;

FIG. 5 shows an operational flow for searching a database of information about files that is indexed based on the files' respective pathnames according to one embodiment of the present invention; and

FIG. 6 shows an exemplary computer system that may be adapted to implement embodiments of the present invention.

### DETAILED DESCRIPTION OF THE INVENTION

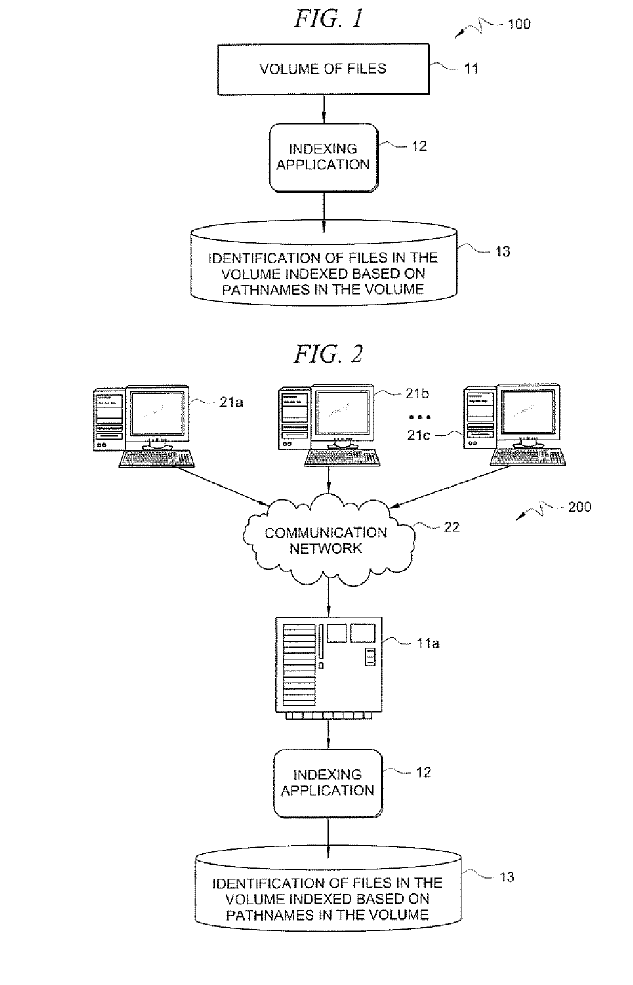

Various embodiments of the present invention are now described with reference to the above figures, wherein like reference numerals represent like parts throughout the several views. FIG. 1 shows an exemplary system 100 according to one embodiment of the present invention. System 100 comprises a volume of files 11 and an indexing application 12 that is operable to construct a pathname-based index of information about the files in volume 11, as discussed further herein. Thus, a database 13 stores information about the files in volume 11, such as the file names and/or other information about the files (e.g., metadata), wherein such information is indexed based on the pathnames using the pathname-based indexes constructed by indexing application 12. As discussed further herein, indexing application 12 may be a computer-executable software program stored to a computer-readable medium and executing on a processor-based device to perform the functionality described further herein for constructing pathname-based indexes. Further, the volume of files 11 may contain any types of electronic files that are stored to any suitable computer-readable data storage medium, including without limitation internal or external disk drives, floppy disks or other magnetic data storage medium, optical disks or other optical data storage medium, Compact Discs (CDs), Digital Versatile Discs (DVD), memory, and/or other data storage devices now known or later developed for storing electronic data.

FIG. 2 shows another exemplary system 200 according to an embodiment of the present invention. In this exemplary system 200, one or more client computers 21A-21C are communicatively coupled via a communication network 22 with a file server 11A, to which a volume of files (e.g., volume 11 of FIG. 1) is stored for the various clients. While three client computers 21A-21C are shown in this example, it should be understood that any number of client computers may be so included and communicatively coupled to file server 11A. Similarly, while a single file server computer 11A is shown in this example, it should be understood that in certain implementations file server 11A may be a plurality of communicatively coupled servers to form a volume of files as is well known in the art. Further, the client computers 21A-21C and file server computer 11A may comprise any suitable type of processor-based computer now known or later developed, including without limitation mainframe computer, personal computer (PC), laptop computer, personal digital assistant (PDA), cellular telephone, workstation computer, etc. Communication network 22 may comprise, as examples, the Internet or other Wide Area Network (WAN), an Intranet, Local Area Network (LAN), wireless network, Public (or private) Switched Telephony Network (PSN), a combination of the above, or any other communications network now known or later developed within the networking arts that permits two or more computing devices to communicate with each other.

As described further herein, indexing application 12 and database 13 are also included in system 200. Such indexing application 12 may execute on server 1 IA or on another computer that is communicatively coupled (e.g., via communication network 22) to such server 11A, such as on one or more of client computers 21A-21C, to construct a pathname-based index of information about the volume of files in file server 11A, as discussed further herein. Similarly, database 13 may reside in whole or in part on file server 11A or on another computer to which indexing application 12 is communicatively coupled (e.g., via communication network 22), such as on one or more of client computers 21A-21C. Further, in certain embodiments, a plurality of instances of indexing application 12 may execute, such as one instance on each of client computers 21A-21C, and/or multiple instances of database 13 may exist, such as an instance on each of client computers 21A-21C.

In the example of FIG. 2, a plurality of different users may use clients 21A-21C to store files to file server 11A. The users may access (via communication network 22) files stored to file server 11A, and depending on the access rights implemented, certain users may be able to access files created by other users. However, the users may use different file storage strategies, such as employing different naming conventions for paths (e.g., directories, sub-directories, etc.) and/or for files, which may lead to difficulty and/or inefficiency in users finding a given file that is of interest.

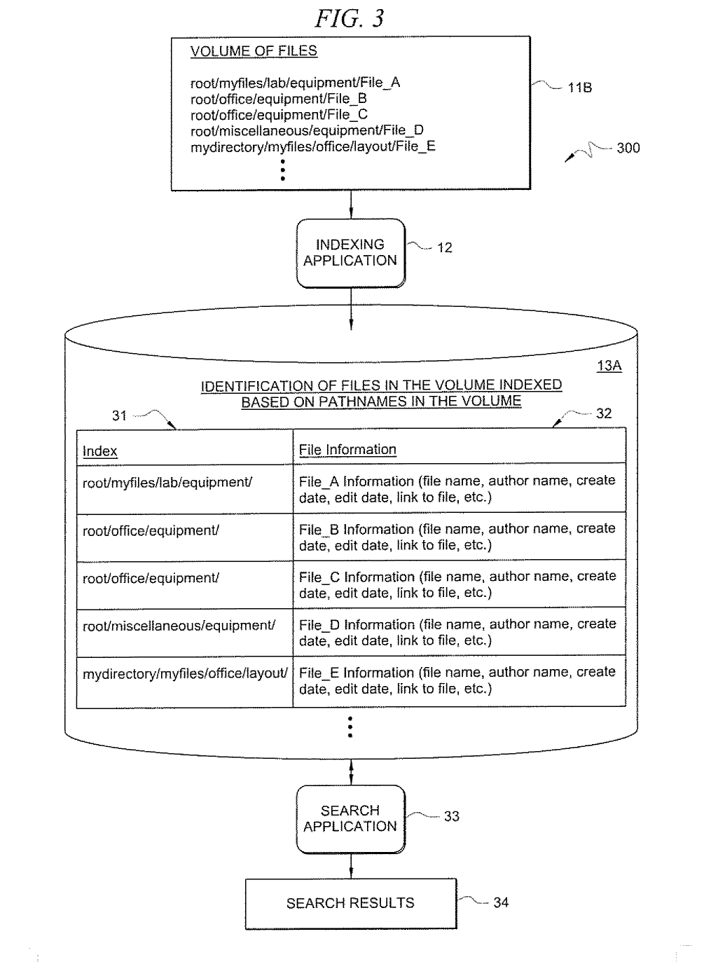

FIG. 3 shows another exemplary system 30, which illustrates an exemplary volume of files 11B and an exemplary database 13A that may be constructed according to one embodiment of the present invention. In the illustrated example, volume 11B includes the following files: File_A, File_B, File_C, File_D, and File_E. The files may each be any type of electronic file, including without limitation a text or word processing file (e.g., .txt, .doc, etc. file), an image file (e.g., .jpeg, etc. file), a .pdf file, a spreadsheet file, a web page file (e.g., html document, etc.), a presentation file (e.g., PowerPoint file, etc.), a music file, or any other type of electronic file now known or later developed. In this example, each of the files is stored in a corresponding path leading to such file. That is, paths (e.g., directories and subdirectories) are created within volume 11B, and the files are each stored to a respective path. For instance, the path leading to File_A in this example is “root/myfiles/lab/equipment/”. The path for both files File_B and File_C is “root/office/equipment/”. The path for File_D is “root/miscellaneous/equipment/”, and the path for File_E is “mydirectory/myfiles/office/layout/”. As is well known in the art, generally a file's path must be traversed to access such file. That is, as is well known in the art, a file can be stored to a given path (e.g., placed in a given location within a directory and its sub-directories), wherein traversing such path leads to the file (i.e., the file is accessible via the path). In certain embodiments, the pathname may further include an indication of a corresponding drive, partition, and/or other logical portion of the volume 11B. For example, a first pathname may be “c:/root/myfiles/”, while another pathname may be “d:/root/myfiles/”, which indicate paths on a “c:” drive and on a “d:” drive of a volume (e.g., of file server 11A) respectively.

Generally, users create all or a portion of the paths for files in a volume 11. For instance, users commonly create directory and/or subdirectory names in which files are placed. As mentioned above, users commonly create pathnames for paths leading to files based on some logical reason relating to the files. That is, the path generally contains some information relating to the files that are stored at such path. Inventors of the present invention have recognized that prior search techniques fail to optimally use the information that is available in the path for locating files of interest. While prior search techniques have been proposed tat make use of various metadata about a file, such as the filename, author name, creation date, file type, etc., the prior search techniques have failed to utilize the information contained in the path leading to a file for searching for the file.

As shown in the example of FIG. 3, according to an embodiment of the present invention, database 13A includes information about the files in the volume 11B indexed by the files' respective pathnames. That is, file information 32 is stored for each file ill volume 11B wherein such file information 32 may include information identifying the file, such as the file name, as well as other metadata for the file, such as the author name, creation date, last edit date, file type, etc., and in some implementations the information may contain a link to the corresponding file, such as a hyperlink for accessing the file. Further, an index 31 is included for the information 32 for each file, wherein such index 31 is constructed by indexing application 12 based on the files' respective pathnames.

In the illustrated example of FIG. 3, for instance, file information 32 is included for File_A, which is indexed by the corresponding index 31 that is the pathname for such File_A in volume 11B (i.e., “root/myfiles/lab/equipment/”). Similarly, information 32 and corresponding pathname-based index 31 is shown for each of files File_B, File_C, File_D, and File_E in this example.

A user (e.g., user of a client computer 21A-21C of FIG. 2) can then search database 13A for a desired file, rather than searching the volume 11B itself. For instance, a search application 33, which is a computer-executable program stored to computer-readable medium, may execute on a client computer 21A-21C and/or on a file server 11A, as examples, for receiving a search criteria from a user for searching for files identified in database 13A that match the search criteria. According to embodiments of the present invention, the search criteria can specify a term or terms that are to be found in a file's path. For instance, a user searching for a file about equipment may define a search criteria that specifies that the pathname is to include the term “equipment”. The index 31 for the files is then searched to identify those database records that match the pathname term. For the term “equipment”, the indexes 31 for files File_A, File_B File_C, and File_D include this term, and so identification of those files may be returned as search results 34, which may be output to a display and/or to other output device (e.g., printer, etc.). Of course, the search criteria may include further criteria in addition to a term in the file pathname, such as creation date, author name, last edit date, and/or other information contained in file information 32, which search application 33 can further use to narrow the search to identify any matching file information in the database 13A. Also, Boolean operators may be used for various search criteria in certain embodiments. For example, a user may define search criteria for searching for files residing in a pathname that contain the terms “office AND equipment” (wherein files File_B and File_C would be returned in the example illustrated in FIG. 3), or the user may define search criteria for searching for files residing in a pathname that contain the terms “lab OR office” (wherein files File_A, File_B, File_C, and File_E would be returned in the example illustrated in FIG. 3).

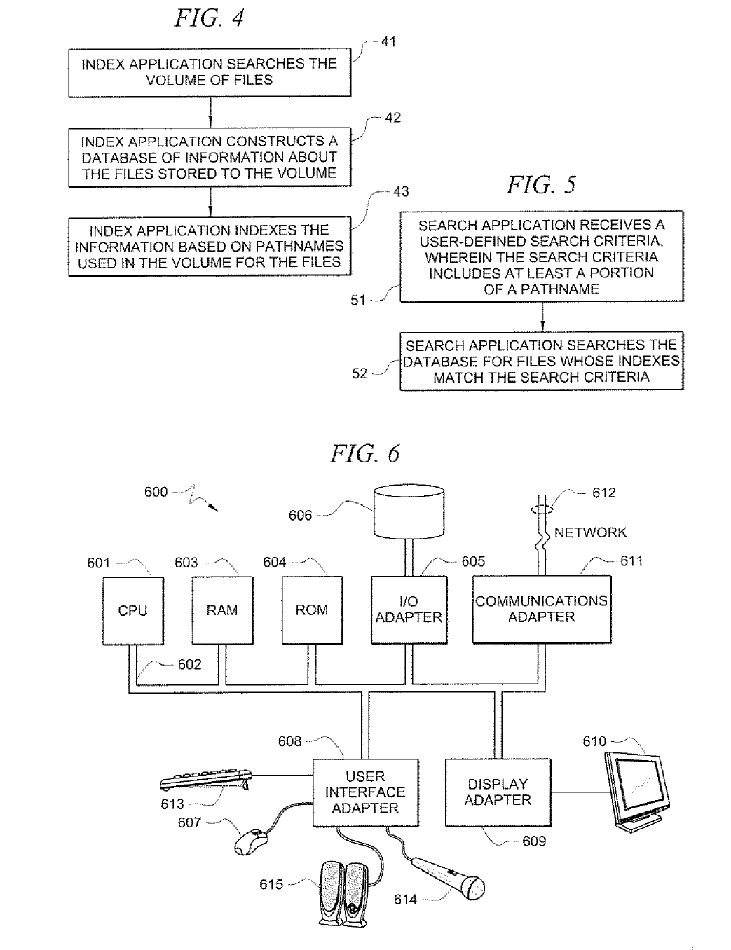

FIG. 4 shows an operational flow according to one embodiment of the present invention. In operational block 41, an indexing application 12 searches the volume of files 11. In certain embodiments, this search of the volume II may be performed by indexing application 12 periodically, such as on a nightly basis, to construct the records in database 13 and the corresponding pathname-based indexes for such records. Such a search of the volume 11 may be conducted by indexing application 12 to discover files and their respective paths that are present in the volume 11. This can be done using operating system commands, for example, such as the DOS DIR command, the UNIX LS command, etc., as those of ordinary skill in the art will readily appreciate.

In block 42, the indexing application 12 constricts a database 13 of information (e.g., information 32) about the files stored to the volume 11. That is, indexing application 12 may gather certain metadata information about the files stored to the volume 11, such as the filename, author name, creation date, last edit date, file type, etc., and store that information for each file to a corresponding record in database 13. In block 43, the indexing application 12 indexes the file information in database 13 based on pathnames used in the volume for the files.

As described above, indexing the file information in database 13 based on the files' respective pathnames can be useful in searching for file that is of interest, particularly when a user lacks sufficient information to find the desired file without searching (e.g., when the user does not know the filename and full path). As described further herein, such indexing according to embodiments of the present invention enables a user (e.g., via search application 33) to utilize logical information often contained in pathnames leading to files for searching for a file that is of interest That is, a user can define a search criteria that includes a pathname-based criteria, such as one or more terms that would likely be contained in the pathname of a desired file, to find files that have pathnames that include such term(s). As used herein, the term “criteria” is intended to encompass one or more criterion, and thus the tern “criteria” may refer to a search term comprising a single criterion or a search term comprising multiple criterion.

Accordingly, FIG. 5 shows an operational flow for searching a database of information about files that is indexed based on the files' respective pathnames according to one embodiment of the present invention. In operational block 51, a search application 33 receives a user-defined search criteria, wherein the search criteria includes at least a portion of a pathname. Flat is, the search criteria includes one or more terms to be searched for inclusion in pathnames that exist in a volume 11. As described further herein, in certain embodiments the search criteria may further include other requirements, such as criteria relating to certain metadata for a file of interest, thus further narrowing the scope of the search. In block 52, the search application 33 searches a database 13 that contains information about the files in volume 11 that is indexed based on the files' respective pathnames. The search application 33 searches the database 13 for files whose indexes match the search criteria. That is, the search application 33 searches the database 13 to determine those database records having a pathname-based index 31 that satisfies the pathname term(s) included in the search criteria, as well as satisfying any other requirements defined in the search criteria (e.g., also containing file information that matches specified metadata requirements defined in the search criteria). The corresponding file information (e.g., identification of the matching files) contained in any database records found by the searching application as satisfying the search criteria are then output to the requesting user (e.g., via a display) as results 34 by the searching application 33.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include ally medium that can store or transfer information.

FIG. 6 illustrates an exemplary computer system 600 adapted according to embodiments of the present invention. That is, computer system 600 comprises an exemplary system on which embodiments of the present invention may be implemented. That is, computer system 600 comprises an exemplary system on which indexing application 12 may reside and execute. Further, search application 33 may reside and execute on such a computer system 600. Additionally, one or more of such exemplary computer system 600 may be used to store a volume of files 11. For instance, computer system 600 may implement a file server, such as exemplary file server 11A described above. Further still, exemplary computer system 600 may be employed as a client (or “user”) computer, such as client computers 21A-21C described above.

According to certain embodiments of the present invention, a practical process that allows the rapid search of large volumes of files, such as NT and/or Unix-based files, is provided. According to one embodiment, such a process involves four steps: 1) the export, by various means (e.g., by indexing application 12), of a text file listing each file in the searched volume 11 with the full directory path to each file and other attributes such as author name, file size and date of creation, etc.; 2) processing of this text file to separate the various elements into standard columns and modify these columns to simplify their use (for example, standardizing date information or extracting the file type); 3) loading the resulting table of information into a relational database with pathname-based indexing performed on every field to allow high-speed searching and retrieval; and 4) the creation of a simple search form (e.g., made available via search application 33), compatible with the chosen relational database to allow users to query the relational table to locate files of interest.

Various file search utilities rely on metadata to assist tie user in identifying files of interest. Previous systems required the user to enter this information at the time they store the file, which represents an increased overhead. To avoid this overhead users may skip this data entry step, or bypass the storage system altogether in favor of quicker, less structured storage locations. Embodiments of this invention take advantage of the fact the there is implicit metadata created by the user by the user's act of navigating through a directory structure to store the data. Specifically, there is a high probability that any file dealing with a company asset “X” will have the word “X” contained somewhere in the directory path or the filename of the file in question. A search of the full path, including the file name will, in most cases, identify the file, even when the user may know little or no other metadata information that may be searched for the files

Central processing unit (CPU) 601 is coupled to system bus 602. CPU 601 may be any general-purpose CPU. Suitable processors include without limitation any processor from HEWLETT-PACKARD's ITANIUM family of processors, HEWLETT-PACKARD's PA-8500 processor, or INTEL's PENTIUM® 4 processor, as examples. However, the present invention is not restricted by the architecture of CPU 601 as long as CPU 601 supports the inventive operations as described herein. CPU 601 nay execute the various logical instructions according to embodiments of the present invention. For example, CPU 601 may execute machine-level instructions according to the exemplary operational flows described above in conjunction with FIGS. 5 and 6. CPU 601 may execute machine-level instructions for performing any of the operations of indexing application 11 and/or search application 33 described herein.

Computer system 600 also preferably includes random access memory (RAM) 603, which may be SRAM, DAM, SDRM, or the like. Computer system 600 preferably includes read-only memory (ROM) 604 which may be PROM, EPROM, EEPROM, or the like. MM 603 and ROM 604 hold user and system data and program-is, as is well known in the art,

Computer system 600 also preferably includes input/output (I/O) adapter 605, communications adapter 61 1, user interface adapter 608, and display adapter 609. I/O adapter 605, user interface adapter 608, and/or communications adapter 611 may, in certain embodiments, enable a user to interact with computer system 600 in order to input information, such as to input a search criteria for searching database 13 for a file of interest based at least in part on the indexed pathname.

I/O adapter 605 preferably connects to storage device(s) 606, such as one or more of hard drive, compact disc (CD) drive, floppy disk drive, tape drive, etc. to computer system 600. The storage devices may be utilized when RAM 603 is insufficient for the memory requirements associated with storing data for indexing application 12 and/or search application 33, as examples. Communications adapter 611 is preferably adapted to couple computer system 600 to network 612 (e.g., communication network 22 described in FIG. 2 above). User interface adapter 608 couples user input devices, such as keyboard 613, pointing device 607, and microphone 614 and/or output devices, such as speaker(s) 615 to computer system 600. Display adapter 609 is driven by CPU 601 to control the display on display device 610 to, for example, display a user interface for receiving search criteria into search application 33 and/or for displaying search results 34 to a user according to certain embodiments of the present invention.

It shall be appreciated that the present invention is not limited to the architecture of system 600. For example, any suitable processor-based device may be utilized, including without limitation personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
constructing a database of information about files stored to a volume of files;
indexing the information based on pathnames for the files in the volume;
receiving a user-defined search criteria, wherein the search criteria includes at least a portion of a pathname; and
searching the database for files whose indexes match the search criteria.

2. The method of claim 1 wherein said indexing is preformed by a computer-executable software process.

3. The method of claim 2 wherein said constructing is performed by said computer-executable software process.

4. The method of claim 1 wherein said receiving and said searching are preformed by a computer-executable software process.

5. The method of claim 1 wherein said pathname comprise directory and subdirectory names to which said files are stored in said volume.

6. The method of claim 1 wherein said pathnames comprise user-defined names.

7. The method of claim 6 wherein said user-defined names comprise names logically related to said files stored to said respective pathnames.

8. The method of claim 1 wherein said information about said files comprises respective links to each of said files.

9. The method of claim 1 wherein said information about said files comprises metadata.

10. The method of claim 9 further comprising:
retrieving from said files in said volume, said metadata.

11. The method of claim 9 wherein said search criteria further includes at least one search term relating to said metadata.

12. The method of claim 1 further comprising:
presenting to a user identification of the files whose indexes match the search criteria.

13. The method of claim 12 further comprising:
presenting to said user a link to the files whose indexes match the search criteria.

14. A system comprising:
a volume of files; and
an indexing application stored to computer-readable medium and executable by a computer to construct a database of information about the files indexed based on the files' respective pathname in the volume.

15. The system of claim 14 wherein the pathnames are user-defined pathnames.

16. The system of claim 14 further comprising a searching application stored to computer-readable medium and executable by a computer to receive a user-defined search criteria that includes at least a portion of a pathname, and said searching application further executable by said computer to search the database for files whose indexes match the search criteria.

17. A system comprising:
means for storing a volume of files, wherein a plurality of different pathnames for accessing the files exist in the volume; and
means for constructing, based on the file's respective pathnames in the volume, indexes for database records of information about the files.

18. The system of claim 17 further comprising;
means for populating the database records with said information about the files.

19. The system of claim 18 wherein the information about the files comprises metadata stored for the files in the volume of files.

20. The system of claim 17 wherein the pathnames comprise directory and subdirectory names.
